(19) United States
(12) Patent Application Publication
(10) Pub. No.: US 2010/0208226 A1
(43) Pub. Date: Aug. 19, 2010

(54) Holographic exposure apparatuses

(75) Inventors: Oui Serg Kim, Seoul (KR); In Bae Jang, Seoul (KR); Sung Jin Lee, Hwaseong-si (KR); Sung Hwi Cho, Seongnam-si (KR); Kyen Hee Lee, Seongnam-si (KR); Sang Joon Hong, Suwon-si (KR); Sang Wook Park, Suwon-si (KR)

Correspondence Address: HARNESS, DICKEY & PIERCE, P.L.C., P.O. BOX 8910, RESTON, VA, 20195, US

(73) Assignee: Samsung Electronic Co., Ltd.

(21) Appl. No.: 12/656,291

(22) Filed: Jan. 25, 2010

(30) Foreign Application Priority Data
Feb. 17, 2009 (KR) 10-2009-0012710

(51) Int. Cl. G03B 27/58; G03H 1/20

(52) U.S. Cl. 355/72; 359/12

(57) ABSTRACT

A holographic exposure apparatus may include an object to be exposed, a holographic mask on which a pattern to be transferred onto the object is formed, a stage to support the mask, and a gap adjustment unit disposed between the mask and stage in order to move the mask relative to the stage. A holographic exposure apparatus also may include an object to be exposed, a mask spaced apart from the object, a holder that holds the mask, and a stage on which the holder is movably mounted such that a gap between the mask and object is adjusted. In addition, a holographic exposure apparatus may include a stage, a prism supported by the stage, a mask spaced apart from the prism and supported by the stage, and a gap adjustment unit disposed between the mask and stage in order to move the mask relative to the prism.

### CROSS-REFERENCE TO RELATED APPLICATION(S)

This application claims priority from Korean Patent Application No. 2009-0012710, filed on Feb. 17, 2009, in the Korean Intellectual Property Office (KIPO), the entire contents of which are incorporated herein by reference.

### BACKGROUND

1. Field

Example embodiments relate to holographic exposure apparatuses that may adjust a gap between an object to be exposed and a holographic mask.

2. Description of the Related Art

Total Internal Reflection (TIR) holographic exposure technology may be applied to patterning processes of a semiconductor Integrated Circuit (IC) or Liquid Crystal Display (LCD) pattern. This exposure technology may include recording a desired pattern onto a holographic mask and/or exposing a photoresist by irradiating a reconstructing beam onto the holographic mask.

In the recording, a recording laser beam may be irradiated onto a mask pattern (former reticle) corresponding to a pattern of an exposure apparatus so as to produce a diffracted beam to be radiated onto a recording surface of a holographic mask. Meanwhile, a reference beam may be irradiated onto the recording surface of the holographic mask from the back side of the holographic mask at an angle (that may or may not be predetermined) so as to interfere with the diffracted beam emitted from the mask pattern. In this way, an interference pattern may be produced and/or recorded on the recording surface of the holographic mask.

In the exposing, an exposing beam, which is a reconstructing beam, may be irradiated from the opposite direction to that in the recording onto an object placed at the same position as in the case of the mask pattern so as to expose a photoresist, together with a diffracted beam, to reconstruct the pattern on the photoresist.

In particular, in the exposing, in order to accurately transfer the interference pattern recorded on the holographic mask onto the object to be exposed, a gap between the object and the holographic mask may be appropriately adjusted. Examples of a method of adjusting this gap to be within a depth of focus may include methods of moving an object and/or methods of simultaneously moving a prism and a holographic mask.

### SUMMARY

Example embodiments may provide holographic exposure apparatuses with improved structure in which a holographic mask may be provided such that a gap between an object and the holographic mask may be easily adjusted.

Additional aspects of example embodiments will be set forth in part in the description that follows and, in part, will be obvious from the description and/or may be learned by practice of example embodiments.

According to example embodiments, a holographic exposure apparatus may include an object to be exposed, a holographic mask on which a pattern to be transferred onto the object is formed, a stage to support the holographic mask, and/or a gap adjustment unit disposed between the holographic mask and the stage to move the holographic mask relative to the stage.

The gap adjustment unit may include a mask holder to fix the holographic mask, and/or the gap adjustment unit may move the mask holder relative to the stage.

The gap adjustment unit may include a piezoelectric element disposed between the stage and the mask holder, and/or a power supply source to supply power to the piezoelectric element.

The stage may include a support part to support the mask holder, the mask holder may include a seat part seated in the support part, and/or the piezoelectric element may be disposed between the support part and the seat part.

The support part may be located under the piezoelectric element and/or the seat part may be located on the piezoelectric element.

The holographic exposure apparatus may further include a distance measurement optical system to measure a distance between the object and the holographic mask, and/or an information processing device to measure information about the distance measurement optical system so as to control the power supply source.

A plurality of piezoelectric elements may be provided.

The holographic exposure apparatus may further include a prism supported by the stage, and/or the gap adjustment unit may move the holographic mask relative to the prism.

According to example embodiments, a holographic exposure apparatus may include an object to be exposed, a holographic mask spaced apart from the object, a mask holder to hold the holographic mask, and/or a stage on which the mask holder is movably mounted such that a gap between the holographic mask and the object is adjusted.

The mask holder may include a piezoelectric element disposed between the stage and the mask holder, and/or a power supply source to supply power to the piezoelectric element.

The stage may include a support part to support the mask holder, the mask holder may include a seat part to support the stage, and/or the piezoelectric element may be disposed between the support part and the seat part.

The piezoelectric element may be located under the mask holder so as to support the load of the mask holder.

According to example embodiments, a holographic exposure apparatus may include a stage, a prism supported by one side of the stage, a holographic mask spaced apart from the prism and supported by the other side of the stage, and/or a gap adjustment unit disposed between the holographic mask and the stage so as to move the holographic mask relative to the prism.

According to example embodiments, since the mask holder may move separately from the mask stage, the movement of the mask holder may be facilitated due to the small size of the mask holder.

In addition, since the gap adjustment unit may include the piezoelectric element so as to move the mask holder with high accuracy, the gap between the holographic mask and the object may be adjusted with high accuracy.

According to example embodiments, a holographic exposure apparatus may comprise an object to be exposed, a holographic mask on which a pattern to be transferred onto the object is formed, a stage to support the holographic mask, and/or a gap adjustment unit disposed between the holographic mask and the stage in order to move the holographic mask relative to the stage.

According to example embodiments, a holographic exposure apparatus may comprise an object to be exposed, a holographic mask spaced apart from the object, a mask holder that holds the holographic mask, and/or a stage on which the mask holder is movably mounted such that a gap between the holographic mask and the object is adjusted.

According to example embodiments, a holographic exposure apparatus may comprise a stage, a prism supported by a first side of the stage, a holographic mask spaced apart from the prism and supported by a second side of the stage, and/or a gap adjustment unit disposed between the holographic mask and the stage in order to move the holographic mask relative to the prism.

### BRIEF DESCRIPTION OF THE DRAWINGS

These and/or other aspects and advantages will become more apparent and more readily appreciated from the following detailed description of example embodiments, taken in conjunction with the accompanying drawings, in which:

FIG. 1 is a view showing the main configuration of a holographic exposure apparatus according to example embodiments;

FIG. 2 is a view showing a coupled state of a mask stage according to example embodiments;

FIG. 3 is a view showing a state in which a gap between a holographic mask and a substrate is out of a depth of focus; and

FIG. 4 is a view showing a state in which the gap between the holographic mask and the substrate is within the depth of focus.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions are exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

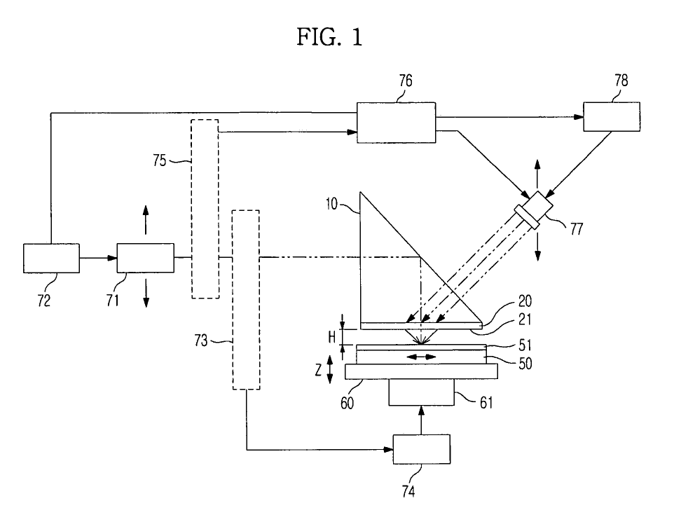

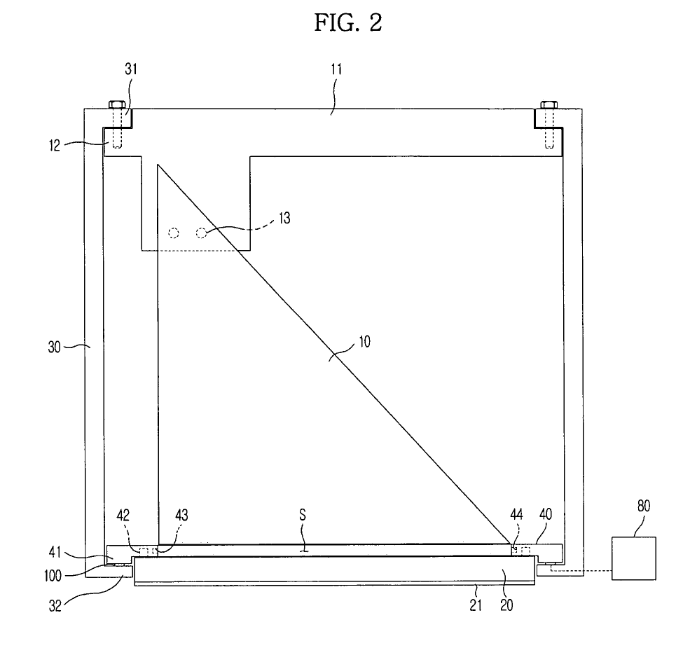

FIG. 1 is a view showing the main configuration of a holographic exposure apparatus according to example embodiments, and FIG. 2 is a view showing a coupled state of a mask stage according to example embodiments.

As shown in FIGS. 1 and 2, the exposure apparatus according to example embodiments may include a mask stage 30 to support a prism 10 and a holographic mask 20, a substrate stage 60 to support a substrate 50, a detection light source 71, a detection light source driving device 72, a distance measurement optical system 73, a first information processing device 74, a thickness measurement optical system 75, a second information processing device 76, an exposure light source 77, and/or an exposure light source driving device 78.

The prism 10 and the holographic mask 20 may correspond to an optical part. A refractive index matching fluid may be filled between the prism 10 and the holographic mask 20. The prism 10 may transmit a reconstructing beam emitted from the exposure light source 77 to the holographic mask 20 while the direction of the reconstructing beam is not changed, and/or may direct a detection beam emitted from the detection light source 71 to the holographic mask 20 in a vertical direction. An interference pattern due to interference of a diffracted beam and a reference beam of a mask pattern (or a reticle) may be recorded on the holographic mask 20. In more detail, the holographic mask 20 may include a recording layer 21 formed of a photosensitive material (e.g., photopolymer). The interference pattern of the diffracted beam and the reference beam may be recorded on the photosensitive material so as to form a hologram (or an interference pattern).

The mask stage 30 may support the prism 10 and/or the holographic mask 20. On the mask stage 30, a prism holder 11 to fix the prism 10 and/or a mask holder 40 to fix the holographic mask 20 may be mounted. Since the prism holder 11 may be fixed to the mask stage 30, the prism holder 11 may not move relative to the mask stage 30. However, the mask holder 40 may be supported by the mask stage 30 so as to move relative to the mask stage 30. This will be described in detail later.

A photosensitive material layer 51 formed of the photosensitive material (that is, photoresist) may be coated on the substrate 50. A substrate stage driving device 61 may hold the substrate 50 on the substrate stage 60 using a vacuum chuck or the like, and/or may move the substrate stage 60 in a horizontal direction (XY direction) and/or a vertical direction (Z direction) so as to adjust the position of the substrate stage. The substrate stage driving device 61 may adjust the position of the substrate stage 60 using information output from the detection light source 71, the distance measurement optical system 73, and/or the first information processing device 74.

The detection light source 71 may emit a measurement beam of the distance measurement optical system 73 and/or the thickness measurement optical system 75. The detection light source driving device 72 may change a detection position while moving the detection light source 71.

The distance measurement optical system 73 may include a beam splitter, a cylindrical lens, an optical sensor, and/or an error signal detector. The distance measurement optical system 73 may measure a distance between the recording layer 21 of the holographic mask 20 and the photosensitive material layer 51 coated on the substrate 50.

The first information processing device 74 may adjust the position of the substrate stage 60 such that a depth of focus is appropriately adjusted upon exposure based on the distance between the recording layer 21 and the photosensitive material layer 51 measured by the distance measurement optical system 73. This is because the gap between the holographic mask 20 and the substrate 50 upon exposure needs to be equal to the gap between the holographic mask 20 and the mask pattern (former reticle) upon recording in order to accurately transfer the interference pattern recorded on the holographic mask 20 to the substrate 50. As the size of the substrate 50 is increased, the load of the substrate stage 60 may be increased. Accordingly, when the substrate stage driving device 61 moves the substrate stage 60, the substrate stage driving device 61 may be burdened by the load of the substrate stage 60 and thus may not accurately move the substrate stage. Therefore, the first information processing device 74 may move the holographic mask 20 so as to uniformly maintain the gap between the holographic mask 20 and the substrate 50. This will be described in detail later.

The thickness measurement optical system 75 may include a beam splitter, a photodetector, an amplifier, and/or an analog/digital (A/D) converter. The thickness measurement optical system 75 may measure the'thickness of the photosensitive material layer 51 formed on the substrate 50.

The second information processing device 76 may move the exposure light source 77 such that the reconstructing beam irradiated from the exposure light source 77 may be scanned on an appropriate exposure region, and/or may control the intensity of the reconstructing beam based on the thickness value of the photosensitive material layer 51 measured by the thickness measurement optical system 75.

The exposure light source 77 may irradiate the reconstructing beam to the recording layer 21 of the holographic mask 20. The exposure light source driving device 78 may expose a desired exposure region of the substrate 50 while moving the exposure light source 77.

The prism holder 11 and/or the mask holder 40 may be mounted on the mask stage 30. The prism holder 11 may be fixed to the mask stage 30. The mask holder 40 may be placed to be moved relative to the mask stage 30.

A fixing part 12 of the prism holder 11 may be supported by a first support part 31 of the mask stage 30, and/or a seat part 41 of the mask holder 40 may be supported by a second support part 32 of the mask stage 30. The fixing part 12 and/or the first support part 31 may be fastened by a bolt or the like such that the prism holder 11 may be fixed to the mask stage 30. In contrast, the mask holder 40 may move relative to the mask stage 30 via a piezoelectric element 100 disposed between the seat part 41 and the second support part 32. That is, when a power supply source 80 supplies power to the piezoelectric element 100, the length of the piezoelectric element 100 may be changed. As the length of the length of the piezoelectric element 100 is changed, the mask holder 40 may move relative to the mask stage 30. Since, due to material characteristics of a piezoelectric element 100, a tensile force may be greater than a compressive force thereof, the piezoelectric element 100 may support the load of the mask holder 40, as shown in FIG. 2. Although the piezoelectric element 100 is described in example embodiments, example embodiments are not limited thereto, and another element to adjust a minute gap may be used.

Since the holographic mask 20 may be fixed to the mask holder 40, the holographic mask 20 may move together with the mask holder 40 so as to move relative to the mask stage 30. The mask holder 40, the piezoelectric element 100, and the power supply source 80 may configure a gap adjustment unit to adjust the gap between the holographic mask 20 and the substrate 50. That is, the gap adjustment unit may move the holographic mask 20 relative to the mask stage 30. Therefore, the holographic mask 20 may be separated from the prism 10 and/or separately moved such that the gap between the holographic mask 20 and the substrate 50 may be adjusted.

The mask holder 40 may fix the holographic mask 20. In the mask holder 40, one or more absorption parts 42 may be formed. Each of the absorption parts 42 may include a vacuum chuck or the like such that the holographic mask 20 is fixed to the mask holder 40.

The prism holder 11 may fix the prism 10. Tongs 13 of the prism holder 11 may be fixed to a sidewall of the prism 10.

If the prism 10 is fixed to the prism holder 11 and the holographic mask 20 is fixed to the mask holder 40, a space S (that may or may not be predetermined) may be provided between the prism 10 and the holographic mask 20. A refractive index matching fluid may be charged in the space S. The refractive index matching fluid may be filled in the inner surface of the mask holder 40. A supply part 43 to supply the refractive index matching fluid may be placed, for example, on one side of an inner circumferential surface of the mask holder 40, and/or a discharge part 44 to discharge the refractive index matching fluid may be placed, for example, on the other side of the inner circumferential surface of the mask holder 40.

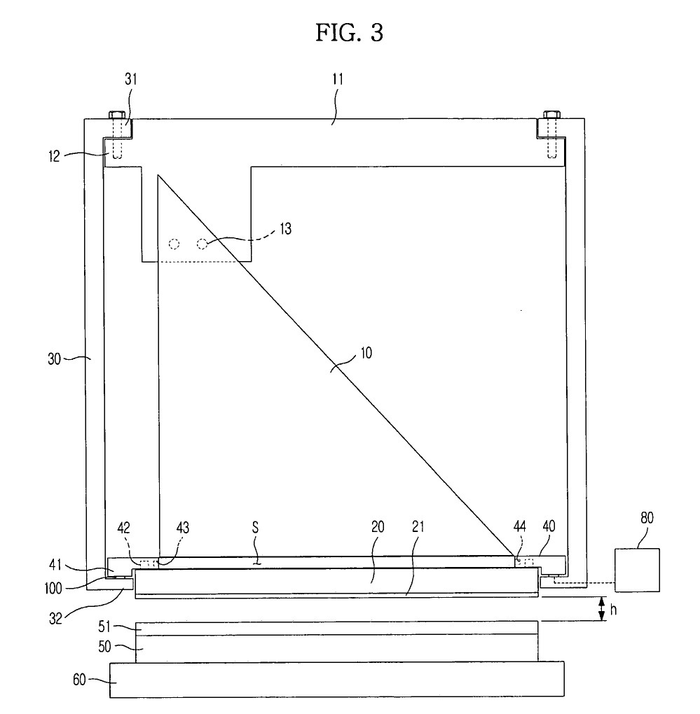

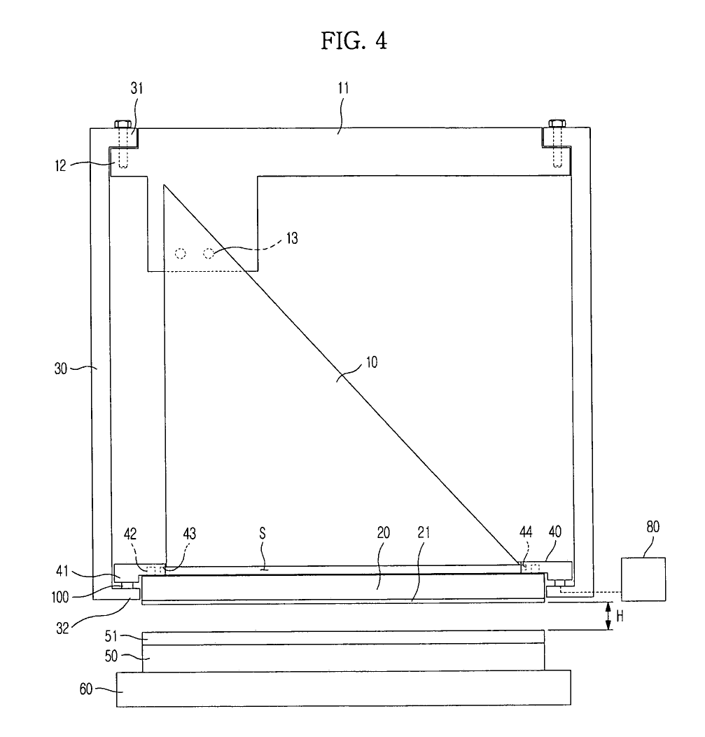

FIG. 3 is a view showing a state in which the gap between the holographic mask 20 and the substrate 50 is out of a depth of focus, and FIG. 4 is a view showing a state in which the gap between the holographic mask 20 and the substrate 50 is within the depth of focus.

According to example embodiments, upon recording, the interference pattern may be recorded on the holographic mask 20 while a gap H (that may or may not be predetermined) between the holographic mask 20 and the mask pattern (former reticle) may be maintained. As shown in FIGS. 1 to 4, in order to accurately transfer the interference pattern recorded on the holographic mask 20 to the photosensitive material layer 51 of the substrate 50 upon exposure, the gap H (that may or may not be predetermined) between the recording layer 21 of the holographic mask 20 and the photosensitive material layer 51 of the substrate 50 may need to be maintained.

The distance measurement optical system 73, the first information processing device 74, and/or the substrate stage driving device 61 may adjust the distance between the recording layer 21 of the holographic mask 20 and the photosensitive material layer 51 coated on the substrate 50, and/or may control the depth of focus upon exposure. That is, the first information processing device 74 may receive an error signal transmitted from the distance measurement optical system 73, may measure the distance between the recording layer 21 of the holographic mask 20 and the photosensitive material layer 51 coated on the substrate 50, may drive the substrate stage driving device 61, and/or may control the position of the substrate stage 60 such that the depth of focus is appropriately adjusted upon exposure. However, if the substrate stage driving device 61 has a large area, the gap between the recording layer 21 of the holographic mask 20 and the photosensitive material layer 51 of the substrate 50 may not be accurately adjusted due to an internal error of the device. In this case, it may be assumed that the gap between the recording layer 21 of the holographic mask 20 and the photosensitive material layer 51 of the substrate 50 is h as shown in FIG. 3. This gap h is not equal to the gap H between the recording layer 21 of the holographic mask 20 and the mask pattern (former reticle).

The first information processing device 74 may control the gap between the recording layer 21 of the holographic mask 20 and the photosensitive material layer 51 coated on the substrate 50 upon exposure with high accuracy such that the gap may be within the depth of focus. That is, the first information processing device 74 may drive the gap adjustment unit based on the error signal of the distance measurement optical system 73, that is, may control the power supply source 80 so as to supply power to the piezoelectric element 100. The piezoelectric element 100 may be deformed according to the level of the supplied power. If the piezoelectric element 100 is deformed, the position of the mask holder 40 supported by the piezoelectric element 100 may be changed, and/or the position of the holographic mask 20 fixed to the mask holder 40 may also be changed. By moving the holographic mask 20 and the mask holder 40 to fix the holographic mask 20, the gap between the recording layer 21 of the holographic mask 20 and the photosensitive material layer 51 coated on the substrate 50 may be controlled to be within the depth of focus with high accuracy. At this time, the gap between the recording layer 21 of the holographic mask 20 and the photosensitive material layer 51 of the substrate 50 may be H as shown in FIG. 4, and/or the gap H may be equal to the gap H between the recording layer 21 of the holographic mask 20 and the mask pattern (former reticle) upon recording.

Thereafter, the exposure light source 77 may direct the reconstructing beam to the prism 10. At this time, an image of the mask pattern (former reticle) may be formed due to the interaction between the reconstructing beam and the interference pattern of the holographic mask 20 and/or may be printed on the photosensitive material layer 51 of the substrate 50.

While example embodiments have been particularly shown and described, it will be understood by those of ordinary skill in the art that various changes in form and details may be made therein without departing from the spirit and scope of the present invention as defined by the following claims.

What is claimed is:

1. A holographic exposure apparatus, comprising:
an object to be exposed;
a holographic mask on which a pattern to be transferred onto the object is formed;
a stage to support the holographic mask; and
a gap adjustment unit disposed between the holographic mask and the stage in order to move the holographic mask relative to the stage.

2. The holographic exposure apparatus of claim 1, wherein the gap adjustment unit includes a mask holder that holds the holographic mask, and
wherein the gap adjustment unit moves the mask holder relative to the stage.

3. The holographic exposure apparatus of claim 2, wherein the gap adjustment unit includes:
a piezoelectric element disposed between the stage and the mask holder; and
a power supply source that supplies power to the piezoelectric element.

4. The holographic exposure apparatus of claim 3, wherein the stage includes a support part to support the mask holder,
wherein the mask holder includes a seat part seated in the support part, and
wherein the piezoelectric element is disposed between the support part and the seat part.

5. The holographic exposure apparatus of claim 4, wherein the support part is located under the piezoelectric element, and
wherein the seat part is located on the piezoelectric element.

6. The holographic exposure apparatus of claim 3, further comprising:
a distance measurement optical system that measures a distance between the object and the holographic mask; and
an information processing device that measures information about the distance measurement optical system in order to control the power supply source.

7. The holographic exposure apparatus of claim 3, wherein the gap adjustment unit includes a plurality of piezoelectric elements.

8. The holographic exposure apparatus of claim 1, further comprising:
a prism supported by the stage;
wherein the gap adjustment unit moves the holographic mask relative to the prism.

9. The holographic exposure apparatus of claim 3, wherein when the power supply source supplies power to the piezoelectric element, the gap adjustment unit adjusts a distance between the holographic mask and the object to be exposed.

10. The holographic exposure apparatus of claim 3, wherein when the power supply source supplies power to the piezoelectric element, the gap adjustment unit adjusts a distance between a recording layer of the holographic mask and the object to be exposed.

11. The holographic exposure apparatus of claim 1, wherein the object to be exposed includes a photosensitive material layer.

12. A holographic exposure apparatus, comprising:
an object to be exposed;
a holographic mask spaced apart from the object;
a mask holder that holds the holographic mask; and
a stage on which the mask holder is movably mounted such that a gap between the holographic mask and the object is adjusted.

13. The holographic exposure apparatus of claim 12, wherein the mask holder includes:
a piezoelectric element disposed between the stage and the mask holder; and
a power supply source that supplies power to the piezoelectric element.

14. The holographic exposure apparatus of claim 13, wherein the stage includes a support part to support the mask holder,
wherein the mask holder includes a seat part acted on by the piezoelectric element, and
wherein the piezoelectric element is disposed between the support part and the seat part.

15. The holographic exposure apparatus of claim 13, wherein the piezoelectric element is located under the mask holder in order to support a load of the mask holder.

16. The holographic exposure apparatus of claim 13, wherein when the power supply source supplies power to the piezoelectric element, a distance is adjusted between the holographic mask and the object to be exposed.

17. The holographic exposure apparatus of claim 13, wherein when the power supply source supplies power to the piezoelectric element, a distance is adjusted between a recording layer of the holographic mask and the object to be exposed.

18. The holographic exposure apparatus of claim 12, wherein the object to be exposed includes a photosensitive material layer.

19. A holographic exposure apparatus, comprising:
a stage;
a prism supported by a first side of the stage;
a holographic mask spaced apart from the prism and supported by a second side of the stage; and
a gap adjustment unit disposed between the holographic mask and the stage in order to move the holographic mask relative to the prism.

20. The holographic exposure apparatus of claim 19, wherein a refractive index matching fluid is disposed between the prism and the holographic mask.
